(19) United States
(12) Patent Application Publication
(10) Pub. No.: US 2026/0145371 A1
(43) Pub. Date: May 28, 2026

(54) INJECTION MOLD FOR CRASH PAD AND CRASH PAD INJECTION MOLDING METHOD

(71) Applicants: HYUNDAI MOTOR COMPANY, SEOUL (KR); KIA CORPORATION, SEOUL (KR); HYUNDAI MOBIS CO., LTD., SEOUL (KR); YONG SAN CO., LTD., ULSAN (KR)

(72) Inventors: Min Chul Yoon, Hwaseong-si (KR); Kwan Woo Lee, Hwaseong-si (KR); Young Jin You, Yongin-si (KR); Hoon Kim, Hwaseong-si (KR); Seong Ho Kim, Ulsan (KR); Jin Pyo Gil, Seongnam-si (KR); Jae Seob Choi, Yongin-si (KR); Do Hyung Kim, Ansan-si (KR); Chang Wan Son, Yongin-si (KR)

(73) Assignees: HYUNDAI MOTOR COMPANY, SEOUL (KR); KIA CORPORATION, SEOUL (KR); HYUNDAI MOBIS CO., LTD., SEOUL (KR); YONG SAN CO., LTD., ULSAN (KR)

(21) Appl. No.: 19/083,416

(22) Filed: Mar. 18, 2025

(30) Foreign Application Priority Data
Nov. 22, 2024 (KR) 10-2024-0168715

(51) Int. Cl. B29C 45/14; B29L 31/30

(52) U.S. Cl. CPC B29C 45/14065; B29L 2031/3038

(57) ABSTRACT

An injection mold for a crash pad is provided, the injection mold includes an upper mold having a first cavity, a lower mold coupled to the upper mold, the lower mold having a second cavity forming a space together with the first cavity when coupled, a lower core slidably connected to the lower mold, the lower core having one surface on which an insert is mounted, and a fixture fastened to the lower core to fix the insert. The fixture is fixed to the lower core by a magnetic force.

### CROSS REFERENCE TO RELATED APPLICATIONS

This application claims benefit of priority to Korean Patent Application No. 10-2024-0168715 filed on Nov. 22, 2024 in the Korean Intellectual Property Office, the disclosure of which is incorporated herein by reference in its entirety.

### BACKGROUND

### 1. Field

The present disclosure relates to an injection mold for a crash pad and a crash pad injection molding method using the same.

### 2. Description of Related Art

A crash pad is a term used to encompass a plastic panel mounted on a lower end of a front windscreen of a vehicle and that is equipped with a steering wheel, a dashboard, and other such components, collectively. An airbag may be embedded in the crash pad. Airbags may serve to tear at a seamline to deploy, in the event of an accident, to protect a passenger from external impacts or forces. The airbags may be covered by a passenger air bag (PAB) door so as not to be externally exposed prior to any deployment, and may be provided in the crash pad. In general, a detachable-type PAB door, manufactured in a state of being separated from a crash pad and then assembled with the crash pad, has been used as a PAB door for covering an airbag. However, recently, a method of manufacturing a PAB door has been used by molding and processing a PAB door integrally with a crash pad and then forming a groove in a rear surface of the crash pad using laser scoring. That is, an integrated-type airbag, capable of enhancing the appearance by preventing a PAB door portion from being exposed to a front surface of the crash pad, has been used.

However, in order to position a scrim in a PAB door, the above described molding method may include a process of inserting the scrim into a cavity of a mold and injecting a resin material to correspond to a position in which the PAB door is formed. In such a process, the scrim may be pushed by a flow of the resin material, and thus may flow without adhering to a preset position. In particular, an inner portion of the PAB door may have a curved uneven shape, such that the scrim may be pushed in a flow direction of the resin material, and at the same time may be lifted toward a skin layer bonded to a surface of the crash pad.

### SUMMARY

Aspects of the present disclosure provide an injection mold for a crash pad and a crash pad injection molding method using the same, capable of stably fixing a scrim when a crash pad is injection molded, and reducing manufacturing costs.

According to an aspect of the present disclosure, there is provided an injection mold for a crash pad, the injection mold including an upper mold having a first cavity, a lower mold coupled to the upper mold, the lower mold having a second cavity forming a space together with the first cavity when coupled, a lower core slidably connected to the lower mold, the lower core having one surface on which an insert is mounted, and a fixture fastened to the lower core to fix the insert. The fixture may be fixed to the lower core by magnetic force.

The lower core may include a body portion having one surface including an insert mounting portion, and an insert fixing portion provided on a side surface of the body portion, the insert fixing portion inserted into the insert to fix the insert. The insert fixing portion may be inserted into the fixture, and the insert may have an edge fixed to a space between the insert fixing portion and the fixture.

The insert fixing portion may include a magnet, and the fixture may include a metal material capable of being coupled to the magnet by magnetic force.

The insert fixing portion may be provided as a plurality of insert fixing portions along a side edge of the body portion.

The insert fixing portion may include a base portion protruding from the side surface of the body portion, the base portion having one surface including a magnet coupling groove, a magnet inserted into and coupled to the magnet coupling groove, the magnet having a support pin coupling groove therein, and a support pin having a first end inserted into the support pin coupling groove and a second end inserted into the fixture.

At least one center alignment ring may be coupled to the one end of the support pin, and an outer circumferential surface of the center alignment ring may be closely coupled to an inner circumferential surface of the support pin coupling groove.

The support pin may include a pin part having a first end inserted into the support pin coupling groove and a second end protruding to an upper portion of the base portion, and a stopper protruding in a radially outward direction from an outer circumferential surface of the pin part.

An inner circumferential surface of the fixture may have a screw thread.

According to another aspect of the present disclosure, there is provided a crash pad injection molding method including a lower core raising operation of raising a lower core of a lower mold, an insert mounting operation of mounting an insert on the lower core, an insert fixing operation of fixing an edge of the insert by fastening a fixture to the lower core, a lower core lowering operation of lowering the lower core, a mold close contact operation of allowing an upper mold, coupled to the lower mold, to be in close contact with the lower mold, and an injection molding operation of injection molding a crash pad by injecting a resin material into a space between the upper mold and the lower mold and then curing the resin material.

In the insert fixing operation, the fixture may be fastened to the lower core by magnetic force.

In the lower core raising operation, the lower core may include a body portion having one surface including an insert mounting portion, and an insert fixing portion provided on a side surface of the body portion, the insert fixing portion inserted into the insert to fix the insert, the insert fixing portion including a magnet.

In the insert mounting operation, the insert may be provided as a scrim including at least one of a synthetic fiber or a reinforcing fiber.

The scrim may include a flat plate part mounted on the insert mounting portion, a side plate part bent at both ends of the flat plate part in a width direction to be in contact with the side surface of the body portion, and a fixing part provided as a plurality of fixing parts along an edge of the side plate part, the fixing part into which the insert fixing portion is inserted.

In the insert mounting operation, the insert may be provided as a scrim including at least one of a synthetic fiber or a reinforcing fiber.

In the insert mounting operation, the insert fixing portion may include a base portion protruding from the side surface of the body portion, the base portion having one surface including a magnet coupling groove, a magnet inserted into and coupled to the magnet coupling groove, the magnet having a support pin coupling groove therein, and a support pin having one end inserted into the support pin coupling groove and the other end inserted into the fixture. The support pin may be inserted into the edge of the insert to support the insert.

In the insert fixing operation, the insert may be fixed by inserting the support pin into the fixture.

The support pin may include a pin part having a first end inserted into the support pin coupling groove and a second end protruding to an upper portion of the base portion, and a stopper protruding in a radially outward direction from an outer circumferential surface of the pin part.

In the injection molding operation, the fixture may be insert injection-molded into the crash pad, such that at least a portion of the fixture may be buried in the crash pad.

An inner circumferential surface of the fixture may have a screw thread.

According to an injection mold for a crash pad and a crash pad injection molding method according to example embodiments of the present disclosure, a scrim may be stably fixed during injection molding of a crash pad, and manufacturing costs may be reduced.

### BRIEF DESCRIPTION OF THE FIGURES

The above and other aspects, features, and advantages of the present disclosure will be more clearly understood from the following detailed description, taken in conjunction with the accompanying drawings, in which:

FIG. 1 is a schematic block diagram of an injection mold for a crash pad according to an example embodiment of the present disclosure;

FIG. 2 is a perspective view of a lower mold of an injection mold for a crash pad according to an example embodiment of the present disclosure;

FIG. 3 is an exploded perspective view of a lower mold of an injection mold for a crash pad according to an example embodiment of the present disclosure;

FIG. 4 is a cross-sectional view taken along line I-I′ of FIG. 2;

FIG. 5 is a flowchart of a crash pad injection molding method according to an example embodiment of the present disclosure;

FIG. 6 is a schematic perspective view of a scrim according to an example embodiment of the present disclosure;

FIG. 7 is a perspective view of a lower mold after a lower core is raised according to an example embodiment of the present disclosure;

FIG. 8 is a perspective view of a state in which a scrim is mounted on a lower core according to an example embodiment of the present disclosure;

FIG. 9 is a perspective view of a state in which a fixture is coupled to a lower core to fix a scrim according to an example embodiment of the present disclosure;

FIG. 10 is a perspective view of a lower mold after a lower core is lowered according to an example embodiment of the present disclosure; and

FIG. 11 is a bottom perspective view of a crash pad manufactured using a crash pad injection molding method, according to an example embodiment of the present disclosure.

### DETAILED DESCRIPTION

Various modifications may be made to the example embodiments. Here, the example embodiments should not be construed as being limited to the present disclosure and should be understood to include all changes, equivalents, and replacements within the idea and the technical scope of the disclosure.

Terms such as first, second, A, B, (a), (b), and the like may be used herein to describe components. Each of these terminologies is not used to define an essence, order or sequence of a corresponding component but is used merely to distinguish the corresponding component from other component(s). For example, a first component may be referred to a second component, and similarly the second component may also be referred to as the first component. The term “and/or” may include combinations of a plurality of related described items or any of a plurality of related described items.

The terms such as “portion,” “part,” and the like may be used to describe various components, but the components should not be limited by the terms. The above-described terms may refer to a term indicating not only a physically/visually distinct component, but also a function or component of a corresponding portion even when not clearly divided or partitioned.

The terminology used herein is for the purpose of describing particular example embodiments only and is not to be limiting of the example embodiments. As used herein, the singular forms “a,” “an,” and “the” are intended to include the plural forms as well, unless the context clearly indicates otherwise. As used herein, the term “and/or” includes any one and any combination of any two or more of the associated listed items. It will be further understood that the terms “comprises” and/or “comprising,” when used in this disclosure, specify the presence of stated features, integers, operations, operations, elements, components or a combination thereof, but do not preclude the presence or addition of one or more other features, integers, operations, operations, elements, components, and/or groups thereof.

Unless otherwise defined herein, all terms used herein, including technical or scientific terms, have the same meanings as those generally understood by one of ordinary skill in the art. Terms defined in dictionaries generally used should be construed to have meanings matching contextual meanings in the related art and are not to be construed as having an ideal or excessively formal meaning, unless otherwise defined herein.

In the description below, the terms, such as “upper portion (top portion),” “lower portion (bottom portion),” and the like, used in relation to direction are defined based on the drawings.

Hereinafter, preferred example embodiments of the present disclosure will be described in more detail with reference to the accompanying drawings.

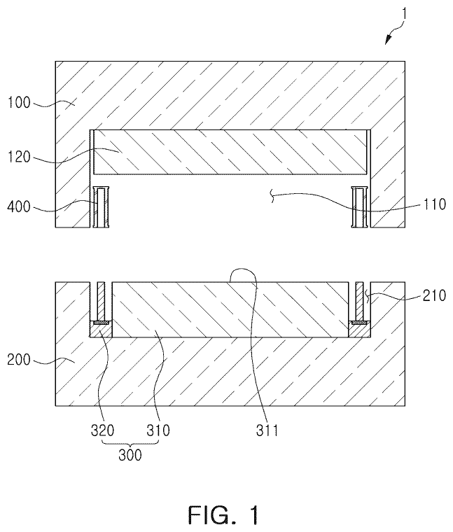

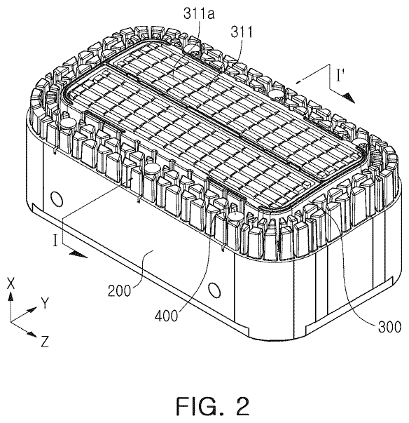

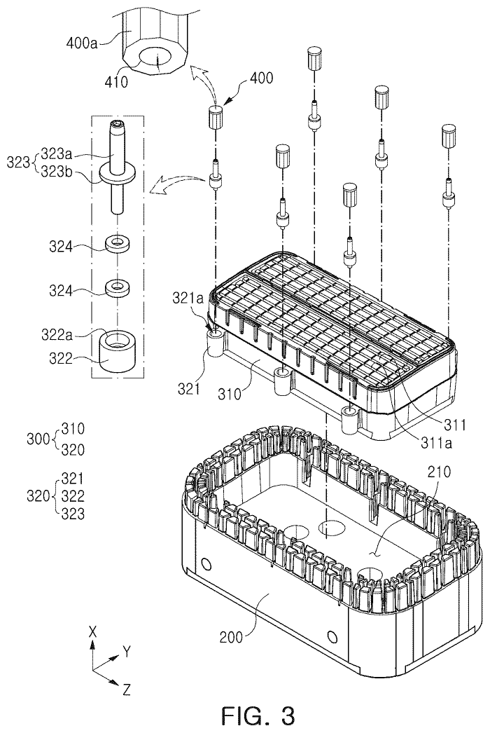

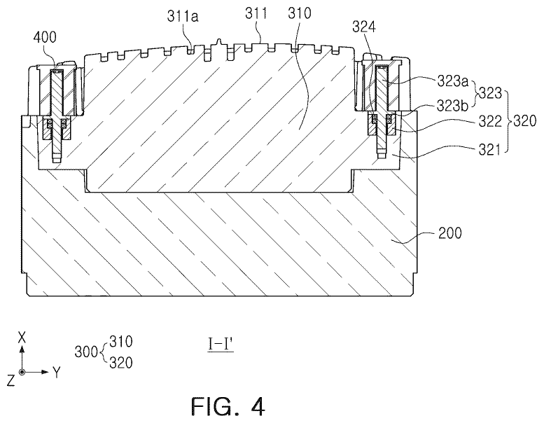

FIG. 1 is a schematic block diagram of an injection mold for a crash pad according to an example embodiment of the present disclosure. FIG. 2 is a perspective view of a lower mold of an injection mold for a crash pad according to an example embodiment of the present disclosure. FIG. 3 is an exploded perspective view of a lower mold of an injection mold for a crash pad according to an example embodiment of the present disclosure. FIG. 4 is a cross-sectional view taken along line I-I′ of FIG. 2.

Referring to FIGS. 1 to 4, an injection mold 1 for a crash pad may include an upper mold 100, a lower mold 200, a lower core 300, and a fixture 400.

The upper mold 100 may be disposed on an upper portion of the lower mold 200. The upper mold 100 may be raised and lowered by operation of a control unit positioned on or otherwise connected to or affixed to the upper portion of the upper mold 200. As the upper mold 100 is raised and lowered, the upper mold 100 may be in close contact with or separated from the lower mold 200. Here, the control unit may control an overall operation of the injection mold 1 for a crash pad according to an example embodiment of the present disclosure, and may be provided as a calculation device including at least one microprocessor.

The upper mold 100 may include a first cavity 110 therein. When the upper mold 100 is lowered so as to be in close contact with the lower mold 200, the first cavity 110 may form a space together with a second cavity 210 of the lower mold 200. A resin material may flow into the space formed by the first cavity 110 and the second cavity 210.

An upper core 120 may be provided in the first cavity 110 of the upper mold 100. The upper core 120 may be provided to be raised or lowered within the first cavity 110. When the upper mold 100 is in close contact with the lower mold 200, the upper core 120 may be lowered to form a resin material inlet space for injection molding a crash pad together with at least one of the upper mold 100, the lower mold 200, or the lower core 300. A lower surface of the upper core 120 may be configured to have a shape corresponding to that of at least a portion of an upper surface of a crash pad 10 manufactured through the injection mold 1 for a crash pad.

The lower mold 200 may be disposed on a lower side of the upper mold 100. At least one of the lower mold 200 or the upper mold 100 may be provided to be raised or lowered. In other words, the upper mold 100 and the lower mold 200 may be in close contact with each other through a raising/lowering operation. To this end, both the upper mold 100 and the lower mold 200 may be provided to be raised or lowered, or one of the upper mold 100 and the lower mold 200 may be provided to be raised or lowered. The lower mold 200 may have the second cavity 210. When the upper mold 100 and the lower mold 200 are in close contact with each other, the second cavity 210 may form a space together with the first cavity 110 of the upper mold 100.

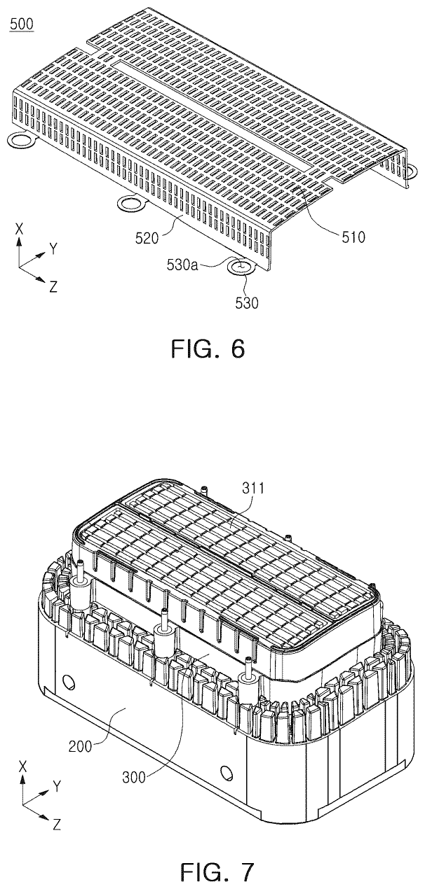

The lower core 300 may be provided in the second cavity 210 so as to be raised or lowered. When a crash pad is manufactured, an insert 500 (see FIG. 6) may be mounted on the lower core 300. The insert 500 may refer to a component that is insert injection-molded into the crash pad 10. The insert 500 may be formed of a fiber material including at least one of a synthetic fiber or a reinforcing fiber. For example, the insert 500 may be provided as a mesh-structured scrim. Hereinafter, a case in which the insert 500 is provided as a scrim will be described as an example, and a reference numeral for the scrim is denoted by “500” so as to be the same as a reference numeral for the insert.

The scrim 500 may be disposed in the crash pad to prevent a PAB door 12 (see FIG. 11) from scattering toward a passenger when an airbag is deployed due to vehicle impacts.

The lower core 300 may fix the scrim 500 when a resin material is injected into the injection mold 1 for a crash pad. Injection molding may be performed in a state in which the scrim 500 is fixed to the lower core 300. The scrim 500 may be insert injection-molded into the crash pad 10.

For example, the lower core 300 may include a body portion 310 having one surface having an insert mounting portion 311, and an insert fixing portion 320 provided on a side surface of the body portion 310, the insert fixing portion 320 inserted into the scrim 500 to fix the scrim 500.

The body portion 310 may be provided in the second cavity 210 to be raised and lowered. To this end, an actuator, such as a cylinder, may be connected to the body portion 310. The insert mounting portion 311 may be provided on one surface of the body portion 310. For example, the insert mounting portion 311 may be provided on an upper surface of the body portion 310. The insert mounting portion 311 may have a groove 311a into which a resin material is introduced. A central portion of the scrim 500 may be in surface contact with the insert mounting portion 311, and an edge portion of the scrim 500 may be bent to be in contact with a side surface of the body portion 310. The edge portion of the scrim 500 may be fixed to the side surface of the body portion 310 by the insert fixing portion 320.

The insert fixing portion 320 may be provided as a plurality of insert fixing portions 320 along a side edge of the body portion 310. The insert fixing portion 320 may fix the scrim 500 during injection molding of the crash pad 10. The insert fixing portion 320 may have one end that passes through the edge of the scrim 500, which end may then be inserted into the fixture 400. The edge of the scrim 500 may be fixed between the insert fixing portion 320 and the fixture 400. The insert fixing portion 320 may include a magnet, and the fixture 400 may include a metal material capable of being coupled to the magnet by magnetic force. The insert fixing portion 320 and the fixture 400 may be coupled to each other by magnetic force, in some examples.

For example, the insert fixing portion 320 may include a base portion 321 protruding from the side surface of the body portion 310, the base portion 321 having one surface having a magnet coupling groove 321a, a magnet 322 inserted into and coupled to the magnet coupling groove 321a, the magnet 322 having a support pin coupling groove 322a therein, and a support pin 323 having one end inserted into the support pin coupling groove 322a and the other end inserted into the fixture 400.

The base portion 321 may protrude from the side surface of the body portion 310. The base portion 321 may be provided integrally with the body portion 310 or may be manufactured as a separate member from the body portion 310 and coupled to the side surface of the body portion 310. The base portion 321 may have a cylindrical shape, for example. The magnet coupling groove 321a may be provided in one surface of the base portion 321. In some examples, the magnet coupling groove 321a may be provided such that an upper surface of the base portion 321 is recessed to a predetermined depth.

The magnet 322 may be inserted into and coupled to the base portion 321. For example, the magnet 322 may be press-fitted into the magnet coupling groove 321a of the base portion 321. An outer circumferential surface of the magnet 322 may be in close contact with an inner circumferential surface of the magnet coupling groove 321a. The magnet 322 may fix the fixture 400 by applying magnetic force to the fixture 400. The support pin coupling groove 322a may be provided in the magnet 322. The support pin coupling groove 322a may be provided in a center of the magnet 322. The magnet 322 may have a ring shape, for example.

The support pin 323 may be coupled to the magnet 322. For example, the support pin 323 may be inserted into and coupled to the support pin coupling groove 322a of the magnet 322. At least one center alignment ring 324 may be coupled to one end of the support pin 323. The one end of the support pin 323 may be inserted into the center alignment ring 324. An outer circumferential surface of the center alignment ring 324 may be in close contact with an inner circumferential surface of the support pin coupling groove 322a. For example, the support pin 323 may include a pin part 323a having one end inserted into the support pin coupling groove 322a and the other end protruding to an upper portion of the base portion 321, and a stopper 323b protruding in a radially outward direction from an outer circumferential surface of the pin part 323a. The pin part 323a may comprise a rod shape. The other end of the pin part 323a may be inserted into the edge of the scrim 500. The stopper 323b may be provided to align a vertical position of the pin part 323a. A lower surface of the stopper 323b may be in contact with an upper surface of the magnet 322. The pin part 323a and the stopper 323b may be integrally formed during manufacture. Alternatively, the stopper 323b may be manufactured separately from the pin part 323a and later coupled to the rod-shaped pin part 323a.

The support pin 323 may be inserted into the edge of the scrim 500 to fix the scrim 500. The fixture 400 may be coupled to the support pin 323. In an embodiment in which the edge of the scrim 500 is inserted into the support pin 323, the fixture 400 may be coupled to the support pin 323 to fix the scrim 500.

The fixture 400 may fix the scrim 500 together with the insert fixing portion 320. For example, the fixture 400 may be coupled to the support pin 323 of the insert fixing portion 320 passing through the edge of the scrim 500 to fix the scrim 500 when a resin material is injected. An insertion groove 410 may be formed in the fixture 400. The support pin 323 of the insert fixing portion 320 may be inserted into the insertion groove 410. The fixture 400 may include a metal material capable of being coupled to a magnet 322, provided in the insert fixing portion 320, by magnetic force. For example, the fixture 400 may be manufactured by processing the metal material capable of being coupled by magnetic force. The fixture 400 may be insert injection-molded when the crash pad 10 is injection-molded. Accordingly, when an injection molding operation is completed, the fixture 400 may be buried in the crash pad 10. An external surface of the fixture 400 may be an uneven surface 400a in a circumferential direction to improve coupling force with the resin material.

The insertion groove 410 of the fixture 400 may be exposed to a lower surface of the crash pad 10 when injection molding of the crash pad 10 is completed (see FIG. 11). An inner circumferential surface of the insertion groove 410 may have a screw thread. A structure for installing an airbag module may be screw-coupled to the fixture 400. The injection mold 1 for a crash pad according to an example embodiment of the present disclosure may fix the scrim 500 to the lower core 300 using magnetic force, thereby preventing a phenomenon in which the scrim 500 is pushed or lifted in a direction of injection of a resin material during injection molding. In addition, the scrim 500 may be fixed by using the fixture 400 to be insert injection-molded, for installing an airbag module without using a structure for fixing the scrim 500, thereby reducing costs required to manufacture an injection mold.

Hereinafter, a crash pad injection molding method using an injection mold for a crash pad according to an example embodiment of the present disclosure will be described.

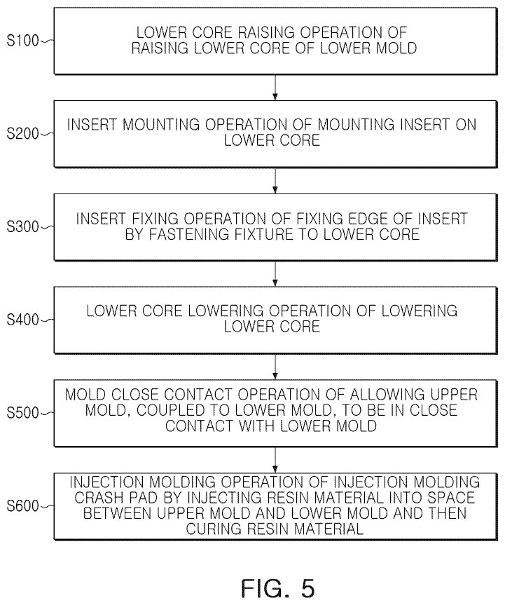

FIG. 5 is a flowchart of a crash pad injection molding method according to an example embodiment of the present disclosure. FIG. 6 is a schematic perspective view of a scrim.

Referring to FIG. 5, the crash pad injection molding method may include a lower core raising operation (S100), an insert mounting operation (S200), an insert fixing operation (S300), a lower core lowering operation (S400), a mold close contact operation (S500), and an injection molding operation (S600). A scrim 500 used in the crash pad injection molding method may be manufactured in advance. The scrim 500 may be insert injection-molded into a crash pad 10 (see FIG. 11), specifically, a portion of the crash pad 10 corresponding to a PAB door 12, to prevent the PAB door 12 from scattering toward a passenger during deployment of an airbag.

Referring to FIG. 6, the scrim 500 may have a mesh structure. For example, the scrim 500 may include a flat plate part 510 mounted on the insert mounting portion 311 of the lower core 300, a side plate part 520 bent at both ends of the flat plate part 510 in a width direction to be in contact with a side surface of the body portion 310 of the lower core 300, and a fixing part 530 provided as a plurality of fixing pars 530 along an edge of the side plate part 520, the fixing part 530 into which the insert fixing portion 320 is inserted. The fixing part 530 may have a fixing hole 530a into which the insert fixing portion 320 is inserted.

The flat plate part 510, the side plate part 520, and the fixing part 530 of the scrim 500 may be integrally molded. In other words, the flat plate part 510, the side plate part 520, and the fixing part 530 may be integrally molded in a scrim fabric preforming operation.

FIG. 7 is a perspective view of a lower mold after a lower core is raised. Referring to FIG. 7, in the lower core raising operation (S100), the lower core 300 of the lower mold 200 may be raised in the second cavity 210. The lower core 300 may be raised by driving an actuator such as a cylinder. As the lower core 300 is raised in the second cavity 210, the lower core 300 may protrude to an upper portion of the lower mold 200. When the lower core 300 protrudes to the upper portion of the lower mold 200, the insert mounting portion 311 of the lower core 300 may be disposed on the upper portion of the lower mold 200.

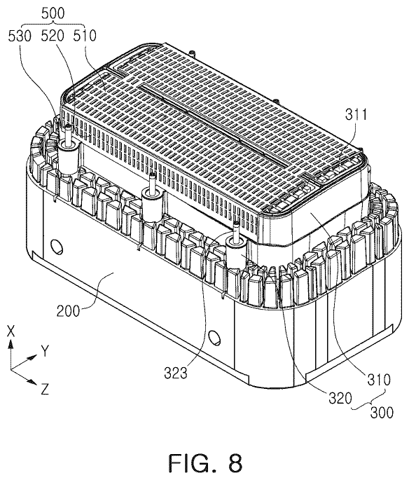

FIG. 8 is a perspective view of a state in which a scrim is mounted on a lower core. Referring to FIG. 8, the insert mounting operation (S200) may be performed after the lower core raising operation (S100). In the insert mounting operation (S200), the flat plate part 510 of the scrim 500 may be mounted on an upper surface of the insert mounting portion 311. The flat plate part 510 of the scrim 500 may have a shape corresponding to that of the upper surface of the insert mounting portion 311. When the flat plate part 510 is mounted on the insert mounting portion 311, the side plate part 520 may be in contact with a side surface of the body portion 310. At the same time, the insert fixing portion 320 may be inserted into the fixing part 530 of the scrim 500. The insert fixing portion 320 may be inserted into an edge of the scrim 500 to support the scrim 500. The insert fixing portion 320 may include a base portion 321 protruding from the side surface of the body portion 310, the base portion 321 having one surface comprising a magnet coupling groove 321a. A magnet 322 is inserted into and coupled to the magnet coupling groove 321a, the magnet 322 having a support pin coupling groove 322a therein, and a support pin 323 having a first end inserted into the support pin coupling groove 321a and a second end inserted into the fixture 400 (see FIG. 3).

The support pin 323 may be inserted into the fixing part 520 to support the scrim 500. For example, a fixing hole 530a may be provided in the fixing part 530, and the support pin 323 may be inserted into the fixing hole 520a to support the scrim 500.

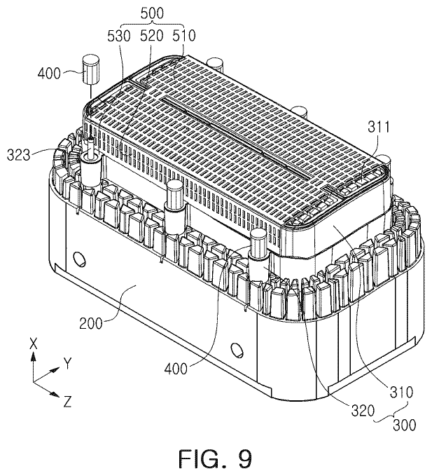

FIG. 9 is a perspective view of a state in which a fixture is coupled to a lower core to fix a scrim. Referring to FIG. 9, the insert fixing operation (S300) may be performed after the insert mounting operation (S200). In the insert fixing operation (S300), the fixture 400 may be fastened to the insert fixing portion 320. For example, the support pin 323 of the insert fixing portion 320 may be inserted into the insertion groove 410 of the fixture 400 to couple the fixture 400 to the insert fixing portion 320. In this case, the fixture 400 may include a metal material capable of being coupled by magnetic force. The fixture 400 may be coupled to the magnet 322 of the insert fixing portion 320 by magnetic force. The first end of the fixture 400 may be in close contact with an upper surface of the base portion 321 of the insert fixing portion 320. The fixing part 520 of the scrim 500 may be interposed between the first end of the fixture 400 and the upper surface of the base portion 321. The fixing part 520 of the scrim 500 may be fixed to the lower core 300 by the insert fixing portion 320 and the fixture 400.

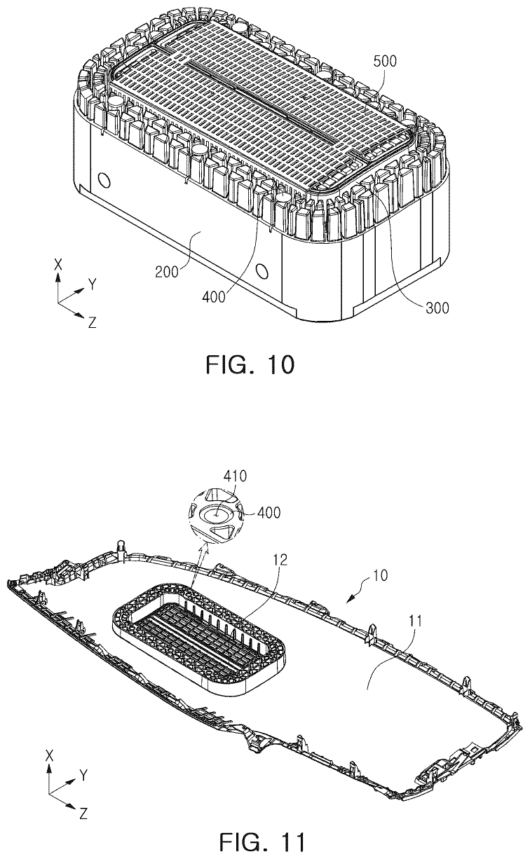

FIG. 10 is a perspective view of a lower mold after a lower core is lowered. Referring to FIG. 10, after the insert fixing operation (S300), the lower core lowering operation (S400) and the mold close contact operation (S500) may be performed. When the upper mold 100 is in close contact with the lower mold 200 after the lower core S300 is lowered, a space into which the resin material is introduced may be formed. After the upper mold 100 and the lower mold 200 are in close contact with each other, the injection molding operation (S600) of injecting a resin material into a mold may be performed. In the injection molding operation (S600), the resin material may be introduced into a space between the upper mold 100 and the lower mold 200, and may be subject to a curing operation.

FIG. 11 is a bottom perspective view of a crash pad manufactured using a crash pad injection molding method according to an example embodiment of the present disclosure. Referring to FIG. 11, the crash pad 10 may be finally manufactured after the injection molding operation (S600). In this case, the fixture 400 may be insert injection-molded, such that at least a portion of the fixture 400 may be buried in the crash pad 10. The insertion groove 410 of the fixture 400 may be exposed to a lower surface of the crash pad 10. An inner circumferential surface of the insertion groove 410 may comprise a screw thread. An airbag module component may be coupled to the insertion groove 410.

While example embodiments have been shown and described above, it will be apparent to those skilled in the art that modifications and variations could be made without departing from the scope of the present disclosure as defined by the appended claims.

1. An injection mold for a crash pad, the injection mold comprising:
an upper mold having a first cavity;
a lower mold coupled to the upper mold, the lower mold having a second cavity forming a space together with the first cavity when coupled;
a lower core slidably connected to the lower mold, the lower core having one surface upon which an insert is mounted; and
a fixture fastened to the lower core to fix the insert,
wherein the fixture is fixed to the lower core by a magnetic force.

2. The injection mold of claim 1, wherein the lower core includes:
a body portion having one surface including an insert mounting portion; and
an insert fixing portion provided on a side surface of the body portion, the insert fixing portion inserted into the insert to fix the insert,
wherein the insert fixing portion is inserted into the fixture, and the insert has an edge fixed to a space between the insert fixing portion and the fixture.

3. The injection mold of claim 2, wherein the insert fixing portion includes a magnet, and the fixture includes a metal material capable of being coupled to the magnet by magnetic force.

4. The injection mold of claim 2, wherein the insert fixing portion is provided as a plurality of insert fixing portions along a side edge of the body portion.

5. The injection mold of claim 2, wherein the insert fixing portion includes:
a base portion protruding from the side surface of the body portion, the base portion having one surface including a magnet coupling groove;
a magnet inserted into and coupled to the magnet coupling groove, the magnet having a support pin coupling groove therein; and
a support pin having a first end inserted into the support pin coupling groove and a second end inserted into the fixture.

6. The injection mold of claim 5, wherein at least one center alignment ring is coupled to the one end of the support pin, and an outer circumferential surface of the center alignment ring is closely coupled to an inner circumferential surface of the support pin coupling groove.

7. The injection mold of claim 6, wherein the support pin includes:
a pin part having a first end inserted into the support pin coupling groove and a second end protruding to an upper portion of the base portion; and
a stopper protruding in a radially outward direction from an outer circumferential surface of the pin part.

8. The injection mold of claim 1, wherein an inner circumferential surface of the fixture has a screw thread.

9. A crash pad injection molding method comprising:
a lower core raising operation of raising a lower core of a lower mold;
an insert mounting operation of mounting an insert on the lower core;
an insert fixing operation of fixing an edge of the insert by fastening a fixture to the lower core;
a lower core lowering operation of lowering the lower core;
a mold close contact operation of allowing an upper mold, coupled to the lower mold, to be in close contact with the lower mold; and
an injection molding operation of injection molding a crash pad by injecting a resin material into a space between the upper mold and the lower mold and then curing the resin material,
wherein, in the insert fixing operation, the fixture is fastened to the lower core by magnetic force.

10. The crash pad injection molding method of claim 9, wherein, in the lower core raising operation, the lower core includes:
a body portion having one surface including an insert mounting portion; and
an insert fixing portion provided on a side surface of the body portion, the insert fixing portion inserted into the insert to fix the insert, the insert fixing portion including a magnet.

11. The crash pad injection molding method of claim 10, wherein, in the insert mounting operation, the insert is provided as a scrim including at least one of a synthetic fiber or a reinforcing fiber.

12. The crash pad injection molding method of claim 11, wherein the scrim includes:
a flat plate part mounted on the insert mounting portion;
a side plate part bent at both ends of the flat plate part in a width direction to be in contact with the side surface of the body portion; and
a fixing part provided as a plurality of fixing parts along an edge of the side plate part, the fixing part into which the insert fixing portion is inserted.

13. The crash pad injection molding method of claim 10, wherein
in the insert mounting operation, the insert fixing portion is inserted into the edge of the insert to support the insert, and
in the insert fixing operation, the insert fixing portion is inserted into the fixture, such that the edge of the insert is fixed between the insert fixing portion and the fixture.

14. The crash pad injection molding method of claim 10, wherein
in the insert mounting operation, the insert fixing portion includes:
a base portion protruding from the side surface of the body portion, the base portion having one surface including a magnet coupling groove;
a magnet inserted into and coupled to the magnet coupling groove, the magnet having a support pin coupling groove therein; and
a support pin having a first end inserted into the support pin coupling groove and a second end inserted into the fixture, and
the support pin is inserted into the edge of the insert to support the insert.

15. The crash pad injection molding method of claim 14, wherein, in the insert fixing operation, the insert is fixed by inserting the support pin into the fixture.

16. The crash pad injection molding method of claim 14, wherein the support pin includes:
a pin part having one end inserted into the support pin coupling groove and the other end protruding to an upper portion of the base portion; and
a stopper protruding in a radially outward direction from an outer circumferential surface of the pin part.

17. The crash pad injection molding method of claim 9, wherein, in the injection molding operation, the fixture is insert injection-molded into the crash pad, such that at least a portion of the fixture is buried in the crash pad.

18. The crash pad injection molding method of claim 17, wherein an inner circumferential surface of the fixture has a screw thread.
